(19) United States
(12) Patent Application Publication
(10) Pub. No.: US 2026/0084644 A1
(43) Pub. Date: Mar. 26, 2026

(54) AIRBAG DEVICE HAVING A TETHER MECHANISM

(71) Applicant: AUTOLIV DEVELOPMENT AB, Vargarda (SE)

(72) Inventors: Johann UNGER, Rohrbach (DE); Jens EHLERS, Horst (DE); Andre GAJEK, Norderstedt (DE); Dietmar LEGDE, Hamburg (DE); Melanie PLACZEK, Barmstedt (DE); Leif SCHATTAUER, Elmshorn (DE)

(21) Appl. No.: 19/109,873

(22) PCT Filed: Sep. 6, 2023
(86) PCT No.: PCT/EP2023/074409

§ 371 Date: Mar. 7, 2025

(30) Foreign Application Priority Data
Sep. 7, 2022 (DE) 10 2022 122 665.4

(51) Int. Cl. B60R 21/2338

(52) U.S. Cl. CPC B60R 21/2338; B60R 2021/23386

(57) ABSTRACT

An airbag device comprising at least one airbag module and at least one arrestor strap mechanism, wherein the at least one airbag module comprises at least one airbag, and the at least one arrestor strap mechanism comprises at least one arrestor strap arrangement and at least one tightening device for the at least one arrestor strap arrangement, wherein an end of an arrestor strap arrangement is attached to an airbag, and the tightening device pulls at least one arrestor strap of the arrestor strap arrangement in a pulling direction during a tightening operation, wherein at least one backstop is provided with which the arrestor strap can be prevented from being pulled out counter to the pulling direction after the tightening operation.

The present invention relates to an airbag device with at least one airbag module and at least one arrestor strap mechanism. The airbag module comprises at least one airbag, while the at least one arrestor strap mechanism comprises at least one arrestor strap arrangement and at least one tightening device for the at least one arrestor strap arrangement. One end of an arrestor strap arrangement is attached to an airbag, wherein a tightening device pulls at least one arrestor strap of the arrestor strap arrangement in a pulling direction during a tightening operation.

The invention relates in particular to a vehicle seat for a motor vehicle with a backrest, a seat and such an airbag device, wherein preferably the at least one tightening device is arranged in the seat, while the at least one airbag module is arranged in the backrest.

It can be provided that the airbag device comprises two airbag modules, each of which is arranged in the lateral region of the backrest, while the two associated tightening devices are arranged in the seat. Preferably, each airbag module is assigned a tightening device.

It can be provided that an arrestor strap arrangement comprises exactly one arrestor strap which is attached at one end to the airbag, and the other end of which is connected to the tightening device. Alternatively, it can be provided that an arrestor strap arrangement comprises a plurality of arrestor straps which are connected to one another, one of which is directly connected to the tightening device for carrying out a tightening operation.

The tightening device preferably comprises a linearly accelerated element, the linear movement of which causes the tightening operation. The linearly accelerating element can be driven in a drive direction, for example by means of a pyrotechnic drive or a spring. The arrestor strap connected to the tightening device can in this case be attached directly to the element accelerated in a straight line. However, it can also be provided that the arrestor strap is fixedly connected to the tightening device and is deflected by the element that can be accelerated in a straight line. In the latter case in particular, the distance traveled by the end of the arrestor strap attached to the airbag can be greater than the distance traveled by the linearly accelerated element, with a type of pulley being formed in the tightening device.

The tightening device can, for example, comprise a tensioner tube in which a piston is arranged. When the piston is driven by a compressed gas generated by a gas generator, the tensioner tube forms a kind of cylinder. The piston arranged in the tensioner tube/cylinder can be connected to the previously described linearly accelerating element via a piston rod (which can also be designated a rod-shaped adjustment element) so that the element is directly driven by an acceleration of the piston.

The above-described deflection element can be arranged at the end of the rod-shaped adjustment element opposite the piston. In this case, the tightening device is coupled in particular via the deflection element to the arrestor strap arrangement in such a way that the arrestor strap arrangement is deflected by the deflection element at least before and/or during the tightening operation. The portions of the arrestor strap arranged in front of and behind the deflection element in the direction of the arrestor strap are therefore arranged at an angle to one another. For example, the arrestor strap can be deflected by the deflection element by more than 60°, preferably more than 90° or about 180°. The degree of deflection can be constant during the tightening operation, but can also change during the tightening operation. In a preferred embodiment, a deflection of 180°, which does not change during the tightening operation, is carried out by means of the deflection element. In particular in this context, it can also be provided that the arrestor strap is fixed on one side of the rod-shaped adjustment element and is guided on the opposite side in a guide for the tightening movement of the arrestor strap, wherein the arrestor strap preferably runs laterally offset to the linear direction of movement of the rod-shaped adjustment element. In particular, the arrestor strap runs parallel to the linear movement direction of the rod-shaped adjustment element before and preferably also during the tightening operation.

The arrestor strap and the linearly accelerating deflection element are arranged relative to each other in particular in such a way that a type of pulley is formed, in which the deflection element forms the moving deflection. The end of the arrestor strap arrangement attached to the airbag therefore covers a greater distance during the tightening operation than the linearly accelerating deflection element. In this regard, the arrestor strap mechanism can have one or more deflectors outside the tightening device, with which the arrestor straps of the arrestor strap mechanism are deflected.

The arrestor strap or arrestor straps of the arrestor strap arrangement are made in particular from a stretchable fabric and can be designed in the form of a strap or rope.

The deflection element can preferably be arranged or formed directly on the rod-shaped adjustment element. In an alternative embodiment, however, it is provided that a type of cage is arranged on the rod-shaped adjustment element, in which the deflection element, for example as a deflection roller, is mounted. The cage driven by the rod-shaped adjustment element is located in particular in a housing of the tightening device and can, if necessary, be guided by the housing during its linear movement.

The airbag, arranged in particular in the backrest of the vehicle seat in the initial state, is designed in such a way that after it has been triggered, it deploys next to and/or in front of an occupant sitting on the vehicle seat. It can be provided that the arrestor strap arrangement guides the deployment process at least temporarily during the deployment of the airbag, for example when the arrestor strap arrangement is in a tensioned state. It is also conceivable that the arrestor strap arrangement is unwound from a spool during deployment or is tightened from a wound or folded state by the deploying airbag.

The tightening device is provided to retract the arrestor strap arrangement during deployment or at the end of the deployment process and therefore to influence the deployment process or to bring the airbag into a final position after deployment. For example, a portion of the airbag attached in front of the occupant after deployment can be pulled towards the backrest by the tightening device so that the occupant is also pulled towards the backrest.

From US 2019/0248322 A1, for example, a vehicle seat with an airbag device mentioned above is known, in which the tightening device winds up the arrestor strap arrangement for the tightening operation by means of a rotary movement. However, after the tightening operation by winding up the arrestor strap arrangement, the arrestor strap arrangement can be unwound again, whereby an occupant initially restrained by the airbag in the direction of the backrest can move away from the backrest again. However, it is desirable that the arrestor strap arrangement can no longer be pulled out after a tightening operation.

The object of the present invention is therefore to eliminate the disadvantages described with reference to the prior art and in particular to specify an airbag device in which a retaining function of the airbag connected to the arrestor strap arrangement is still present even after the end of the tightening operation.

One possible solution to this problem is given by the airbag device having the features of the independent claim. Other solutions and advantageous developments of the airbag device are specified in the description above and in the following, wherein individual features of the solutions and developments can be combined with one another in a technically sensible manner.

The object is achieved in particular by an airbag device with the features mentioned at the outset, in which at least one backstop is provided with which it is possible to prevent the arrestor strap from being pulled out counter to the pulling direction after the tightening operation.

In other words: The basic idea of the invention is that the backstop provides a device element which is configured such that the arrestor strap pulled in the pulling direction by the tightening device is not pulled out again in the opposite direction, for example by an occupant pressed into the airbag. One or more backstops can be provided for this purpose. A plurality of backstops with the same mechanism of action or backstops with different mechanisms of action can be provided. Preferably, therefore, at least two backstops with different mechanisms of action or even three backstops with different mechanisms of action are provided. Accordingly for example, at least one first backstop can act on the deflection element, and the latter can be secured against a backward movement in its position displaced, in particular linearly, by a drive device. At least one second backstop can act directly on an element of the drive device (such as a spring or a rod-shaped element of a piston/cylinder arrangement). At least a third backstop can act directly on the arrestor strap of the arrestor strap arrangement. With the at least one backstop, the pulling out of the arrestor strap at the end of a tightening operation is prevented so that if need be it can be pulled out counter to the original pulling direction under very large forces overcome the backstop.

In principle, it is possible for the backstop to be arranged as a separate component to the tightening device. However, it is preferred that the backstop is integrated in the tightening device and/or is attached as a component in/on the tightening device so that the tightening device with the backstop can be attached as a structural unit to a vehicle seat. In this case, the tightening device therefore comprises at least one backstop and preferably all backstops.

In a first specific embodiment, it is proposed that the tightening device comprises a deflection element described at the onset which can be driven in a drive direction, and the deflection element deflects the arrestor strap of the arrestor strap arrangement in the tightening device, wherein at least one (first) backstop prevents a movement of the deflection element counter to the drive direction.

In this context, it can in particular be provided that the deflection element is for example rotatably mounted on a cage, and the cage can be driven within a housing in the drive direction, wherein a (first) backstop has a clamping element provided on the cage, which clamping element prevents movement of the cage in the housing counter to the drive direction.

For example, a component can be provided which prevents the deflection element moved in a straight line for example by a pyrotechnic drive or a spring from being blocked or jammed when moving counter to the drive direction. For example, plates, balls, rings or the like may be arranged relative to each other in such a way that a corresponding movement counter to the drive direction is prevented.

In this specific case, for example, an in particular metallic plate can be arranged on the cage in such a way that it slides along an inner side of the housing when the cage moves in the drive direction, while the plate engages with its edges in a surface of the housing upon moving in the opposite direction counter to the drive direction and thereby blocks a backward movement of the cage.

Alternatively, it can be provided that one element or several elements of a backstop act on an element of the drive device and in particular on a drivable rod-shaped adjustment element of the tightening device, wherein the backstop acts directly on the rod-shaped adjustment element. Accordingly, a piston rod of a piston/cylinder unit can be blocked in its extended position by the backstop which prevents a backward movement of the piston rod. Such a (second) backstop can act inside the cylinder or outside the cylinder. It can also be provided that at least two second backstops are provided, one of which acts inside the cylinder on the piston rod and the other outside the cylinder on the piston rod.

For example, the (second) backstop can have a first locking element that at least in portions changes conically along the piston rod and a second locking element interacting with the conical section of the first locking element. The locking elements are preferably designed annular and surround the rod-shaped adjustment element. The two locking elements are arranged relative to one each other in such a way that the piston rod can be pushed out of the cylinder in the drive direction, wherein, due to a return movement of the piston rod, the first locking element interacts with the second locking element, whereby the return movement of the piston rod is also stopped. During a return movement, the annular second locking element is either clamped between the locking element and the piston rod by a conically tapering section of the first locking element or clamped between a conically tapering element and the inside of the cylinder. Upon a movement of the piston rod in the drive direction, the annular second locking element contrastingly rests on a flat surface aligned orthogonally to the piston rod so that the piston rod is movable.

At least one (third) backstop can act directly on the arrestor strap of the arrestor strap arrangement, wherein it is provided in particular that the (third) backstop has ribs along which the arrestor strap is guided, wherein the ribs are designed such that the arrestor strap is movable in the pulling direction and is blocked by the ribs counter to the pulling direction. The ribs are formed in particular by a plurality of parallel elongated projections. In this case, the ribs can be aligned in the pulling direction of the arrestor strap in such a way that during a movement of the arrestor strap counter to the pulling direction, the arrestor strap is automatically pressed onto a surface.

In particular, it can be provided that the (third) backstop has two groups of ribs between which the arrestor strap is guided. The ribs can be formed as a single piece on a component. For example, the longitudinally extending ribs can be aligned at an angle of, for example, between 30° and 60° to the pulling direction of the arrestor strap in such a way that the arrestor strap is pressed by the ribs onto a base of the backstop during a movement counter to the pulling direction, in particular if the ribs of the two groups are aligned parallel to one another and have a constant distance from one another. However, the ribs of the two groups do not have to be aligned strictly parallel to each other. Accordingly in a special embodiment, it can be provided that the ribs are arranged in a V-shape relative to one another in such a way that the distance between the ribs of the two groups is reduced in the direction of the ground towards which the arrestor strap is moved during a movement counter to the pulling direction, whereby the clamping effect can be increased.

In addition, it can be provided that the mutual distance between the ribs arranged one behind the other in the direction of the arrestor strap decreases in the pulling direction, whereby the load in the arrestor strap is distributed more evenly. A pair of two ribs arranged on either side of the arrestor strap therefore has a lesser distance from each other than a pair of ribs arranged behind it in the pulling direction.

In this context, it can further be provided that the (third) backstop comprises at least one cable guide which is designed and arranged such that, while loading the arrestor strap arrangement counter to the pulling direction, the arrestor strap is loaded against a base of the ribs arranged in a V-shape relative to one another. The cable guide is formed, for example, by a projection arranged in front of or behind the ribs in the direction of the arrestor strap or another physical structure over which the arrestor strap is guided, wherein when loading the arrestor strap counter to the pulling direction, the cable guide loads the arrestor strap at least partially in the direction of the base of the ribs arranged in a V-shape so that during a subsequent movement of the arrestor strap counter to the pulling direction, the arrestor strap is automatically clamped.

The invention and the technical environment are explained below by way of example with reference to the figures. Schematically, in the figures:

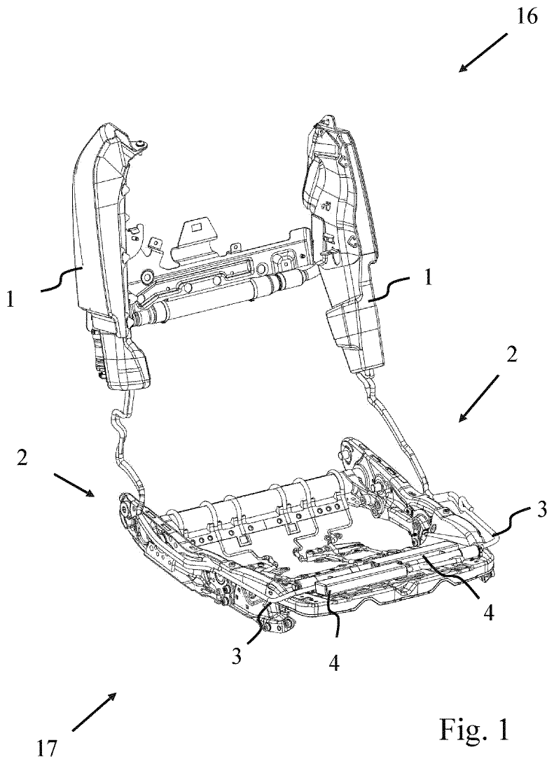

FIG. 1: is a part of a frame of a vehicle seat with an airbag device,

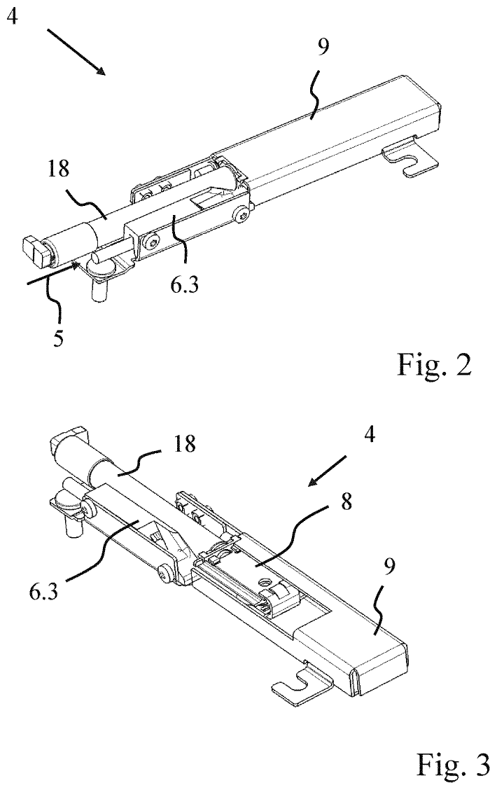

FIG. 2: is a perspective view of a tightening device of the airbag device,

FIG. 3: is the tightening device according to FIG. 2 in another perspective view in partial sectional view,

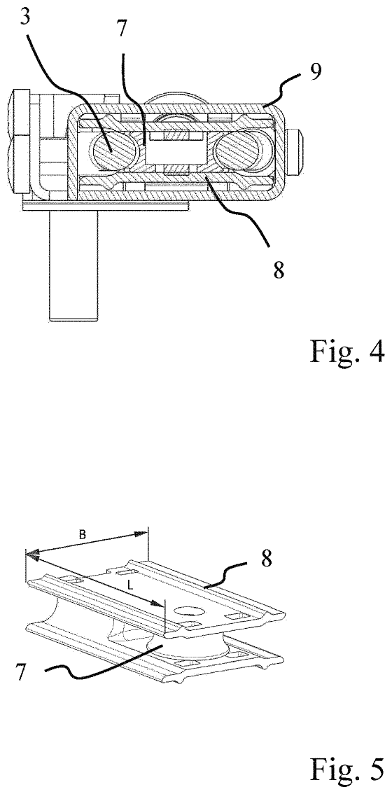

FIG. 4: is a sectional view through the tightening device according to FIGS. 2 and 3; and

FIG. 5: is a cage with a deflection element of the tightening device,

FIG. 6 to 9: are different possibilities for fixing the arrestor strap to a housing of the tightening device,

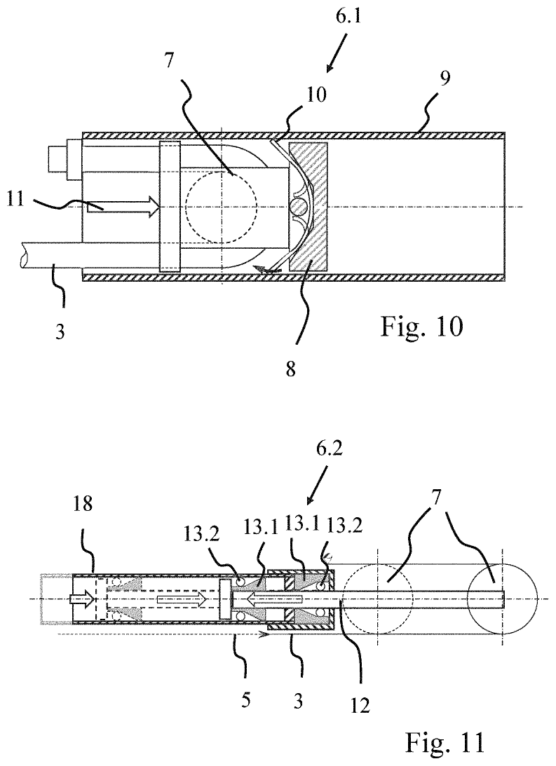

FIG. 10: is a sectional view through a tightening device with a first backstop,

FIG. 11: is a sectional view through a tightening device with a second backstop,

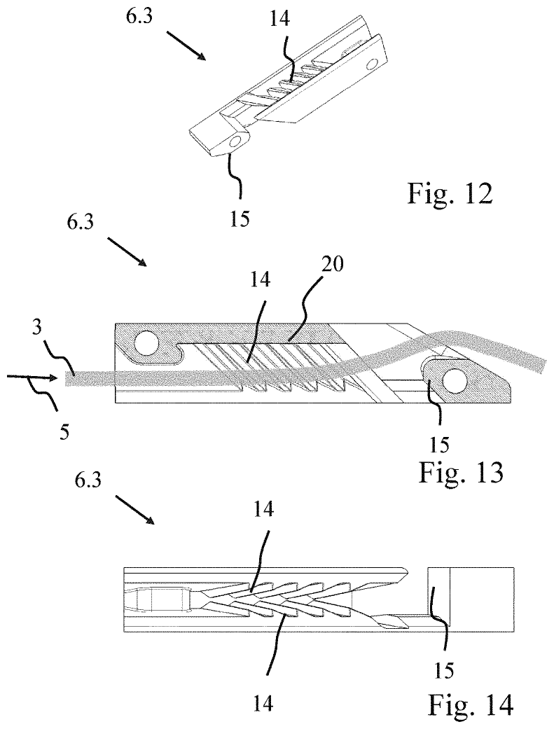

FIG. 12: is a perspective view of a third backstop,

FIG. 13: is a sectional view through the third backstop, and

FIG. 14: is a top view of the third backstop.

A part of a frame of a vehicle seat is show in FIG. 1. The vehicle seat comprises a seat 17 and a backrest 16. An airbag device is integrated into the vehicle seat and comprises two airbag modules 1 and two arrestor strap mechanisms 2.

The airbag modules 1 are arranged in a lateral region of the backrest 16. The airbags, which are only shown in a folded state within a cover in FIG. 1, deploy in front of and/or next to an occupant located on the vehicle seat in the event of being triggered. The airbag modules 1 each also comprise a gas generator with which the airbags can be deployed.

The arrestor strap mechanisms 2 each have a tightening device 4 and an arrestor strap arrangement. An arrestor strap 3 of the arrestor strap arrangement is connected to a tightening device 4, wherein one end of the arrestor strap 3 is connected to the airbag. In the event of being triggered, the deploying airbags can be guided with the tightened arrestor strap arrangements, wherein the arrestor strap arrangements can be retracted by means of the tightening devices so that the deploying or deployed airbag can be brought into a desired position.

The tightening device 4 shown in FIG. 2 to 4 comprises a housing 9 in which a cage 8 is arranged which can be driven to a linear movement by means of a piston-cylinder arrangement. As is evident in FIG. 5, the cage 8 is longer than it is wide in the drive direction so that the cage 8 cannot jam in the housing 9. In addition, the cage 8 has longitudinally extending projection shapes which enable the cage 8 to be guided in the housing 9 with as little friction as possible.

A deflection element 7, with which the arrestor strap 3 is deflected, is mounted on the cage 8.

The arrestor strap 3 is fixed on one side of the piston-cylinder unit to an arrestor strap fastener 19 on the housing 9. From this arrestor strap fastener 19, the arrestor strap 3 runs approximately parallel to the drive direction of the cage 8, is deflected by 180° by the deflection element 7, and exits the tightening device 4 through a third backstop 6.3.

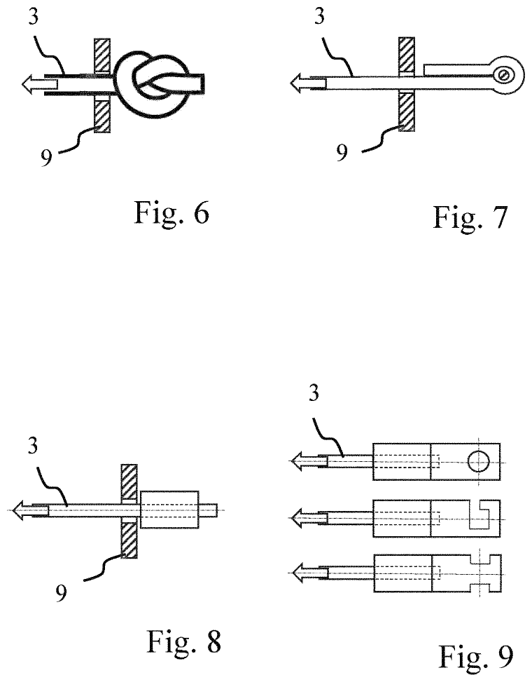

FIG. 6 to 9 show various possibilities of how the arrestor strap 3 can be fastened to the arrestor strap fastener 19 on the housing 9. According to the embodiment in FIG. 6, a knot is introduced into the arrestor strap 3 so that the arrestor strap 3 cannot pass through an opening in the housing 9. According to the embodiment in FIG. 7, an eyelet is formed on the arrestor strap 3 outside the housing 9 of the tightening device 4, for example by sewing, so that the eyelet cannot be pulled through an opening in the housing 9, whereby the arrestor strap 3 is fixed to the housing 9 upon triggering the tightening device 4. According to the embodiment in FIG. 8, a sleeve is fastened to the arrestor strap 3 in a form-fit and/or force-fit or integrally, wherein the sleeve has a larger outer circumference than an opening in the housing 9. The sleeve can be fixed to the arrestor strap 3 in any suitable manner. According to the three embodiments in FIG. 9, a type of sleeve is applied to the end of the arrestor strap 3. At its end, the sleeve has a shape with which the sleeve can be fastened to the housing 9 of the tightening device 4. For example, the sleeve shown in FIG. 9 above can be attached to the housing 9 by means of a screw. The sleeve shown in the middle and bottom of FIG. 9 enables the sleeve to be fixed to the housing in a form-fit and/or force-fit.

When the tightening device 4 is activated, a piston rod, also termed a piston-shaped adjustment element 12, is driven within the cylinder 18 in a drive direction 11 by means of a compressed gas generated by a pyrotechnic drive or by a spring. As a result, the arrestor strap 3 is pulled into the tightening device 4 in a pulling direction 5. Since one end of the arrestor strap 3 is fixed to the arrestor strap fastener 19 on the housing 9 and the arrestor strap 3 is deflected by 180° by the deflection element 7, a tightening path of the other end of the arrestor strap arrangement is twice as large as the path covered by the adjustment element 12.

At the end of a tightening operation, it is desirable that the arrestor strap 3 cannot be pulled out of the tightening device 4 again. A plurality of backstops are proposed for this purpose.

FIG. 10 shows a first backstop 6.1 which is attached to the cage 8. Accordingly, a plate-shaped clamping element 10 is attached to the cage 8 and is bent such that it slides along an inner side of the housing 9 during a tightening movement in the direction of the drive direction 11. However, if the cage 8 is moved counter to the drive direction 11, the edges of the clamping element 10 engage in the inside of the housing 9, thereby preventing further movement counter to the drive direction 11.

According to the second backstop 6.2 shown in FIG. 11, a first locking element 13.1 and a second locking element 13.2 are arranged within the cylinder 18. In addition, a first locking element 13.1 and a second locking element 13.2 are arranged outside the cylinder 18. The first locking elements 13.1 and the second locking elements 13.2 surround the rod-shaped adjustment element 12. The first locking elements 13.1 have a conically tapering section which tapers counter to the drive direction 11. The second locking elements 13.2 are designed annular. During a tightening operation in the drive direction 11, the second annular locking elements 13.2 lie on a flat surface oriented perpendicular to the drive direction 11 and do not hinder the tightening movement. If, however, the rod-shaped adjustment element 12 moves counter to the drive direction 11, the second locking elements 13.2 are pressed by the conical sections of the first locking elements 13.1 either against an inner side of the cylinder 18 or against the adjustment element 12, whereby a movement of the adjustment element 12 counter to the drive direction 11 is blocked. The first locking element 13.1 arranged inside the cylinder 18 is therefore immovably connected to the adjustment element 12 and follows a movement of the adjustment element 12. The first locking element 13.1 arranged outside the cylinder 18, however, is fixed in place so that the adjustment element 12 can move relative to the first locking element 13.1.

FIG. 12 to 14 show a third backstop 6.3 which can also be seen in FIGS. 2 and 3. The third backstop 6.3 comprises two groups of ribs 14, between which the arrestor strap 3 is guided. The arrestor strap 3 enters into the third backstop 6.3 between the ribs 14 via a cable guide 15. The ribs 14 have an inclination relative to the longitudinal extension of the arrestor strap 3 so that the arrestor strap 3 is pulled onto a base 20 of the third backstop 6.3 under a load counter to the pulling direction 5. In addition, the two groups of ribs 14 are arranged relative to each other in such a way that their distance towards the base 20 decreases. In a longitudinal view along the arrestor strap 3, the two groups of ribs are arranged in a V-shape, whereby the clamping effect is further increased while loading the arrestor strap 3 counter to the pulling direction 5. In addition, the mutual distance between the ribs 14 arranged one behind the other in the direction of the arrestor strap decreases in the pulling direction 5, whereby the load in the arrestor strap 3 is distributed more evenly. A pair of two ribs 14 arranged on either side of the arrestor strap 3 therefore has a lesser distance from each other than a pair of ribs 14 arranged behind it in the pulling direction 5.

### LIST OF REFERENCE SIGNS

1 Airbag module
2 Arrestor strap mechanism
3 Arrestor strap
4 Tightening device
5 Pulling direction
6.1 First backstop
6.2 Second backstop
6.3 Third backstop
7 Deflection element
8 Cage
9 Housing
10 Clamping element
11 Drive direction
12 Adjustment element
13.1 First locking element
13.2 Second locking element
14 Ribs
15 Cable guide
16 Backrest
17 Seat
18 Cylinder
19 Arrestor strap fastener
20 Base

1. An airbag device comprising at least one airbag module and at least one arrestor strap mechanism, wherein
the at least one airbag module comprises at least one airbag, and
the at least one arrestor strap mechanism comprises at least one arrestor strap arrangement and at least one tightening device for the at least one arrestor strap arrangement, wherein
an end of an arrestor strap arrangement is attached to an airbag, and the tightening device pulls at least one arrestor strap of the arrestor strap arrangement in a pulling direction during a tightening operation,
wherein
at least one backstop is provided, with which the arrestor strap can be prevented from being pulled out counter to the pulling direction after the tightening operation.

2. The airbag device according to claim 1, wherein the tightening device comprises the at least one backstop.

3. The airbag device according to claim 1, wherein the tightening device comprises a deflection element which can be driven in a drive direction, and the deflection element deflects the arrestor strap of the arrestor strap arrangement in the tightening device, wherein at least one backstop prevents a movement of the deflection element counter to the drive direction.

4. The airbag device according to claim 3, wherein the deflection element is mounted on a cage, and the cage can be driven within a housing in the drive direction, wherein a backstop has a clamping element provided on the cage, which clamping element prevents movement of the cage in the housing counter to the drive direction.

5. The airbag device according to claim 1, wherein the tightening device comprises a drivable rod-shaped adjustment element, wherein a backstop acts directly on the rod-shaped adjustment element.

6. The airbag device according to claim 5, wherein the backstop has a first locking element that at least in portions changes conically along the rod-shaped adjustment element, and a second locking element interacting with the conical portion of the first locking element.

7. The airbag device according to claim 1, wherein a backstop acts directly on the arrestor strap of the arrestor strap arrangement.

8. The airbag device according to claim 7, wherein the backstop has ribs along which the arrestor strap is guided, the ribs being designed such that the arrestor strap is movable in the pulling direction and is locked counter to the pulling direction by the ribs.

9. The airbag device according to claim 8, wherein the backstop has two groups of ribs, between which the arrestor strap is guided, wherein the two groups of ribs are preferably arranged in a V-shape relative to one another.

10. The airbag device according to claim 9, wherein the backstop comprises at least one cable guide which is designed and arranged such that, when the arrestor strap arrangement is loaded counter to the pulling direction, the arrestor strap is loaded against a base of the ribs arranged in a V-shape relative to one another.

11. A vehicle seat for a motor vehicle, comprising
a backrest,
a seat and
the airbag device according to claim 1.
